(19) United States
(12) Patent Application Publication
(10) Pub. No.: US 2011/0162256 A1
(43) Pub. Date: Jul. 7, 2011

(54) Catcher for catching crabs, shrimps or the like

(75) Inventor: Wei-Hsiung Chen, Changhua (TW)

(73) Assignee: DONGSHAN OKEY METAL & PLASTIC PRODUCTS CO., LTD., FUJIAN (CN)

(21) Appl. No.: 12/654,885

(22) Filed: Jan. 7, 2010

(51) Int. Cl. A01K 69/10

(52) U.S. Cl. 43/105

(57) ABSTRACT

A catcher for catching crabs, shrimps or the like includes a flexible frame and a net cover housing the flexible frame. The flexible frame is deformable between a retracted configuration and an extended configuration. The net cover has an inlet tunnel with a cross-section area inwardly and gradually decreased. When the flexible frame stays at the extended configuration, the net cover is supported by the flexible in such a manner that an accommodation in which baits can be provided is formed inside the net cover.

### BACKGROUND OF THE INVENTION

1. Field of the Invention

The present invention relates generally to a catcher for catching crabs, shrimps or the like and more particularly, to a catcher that has a net cover housing a flexible frame that is deformable between a retracted configuration and an extended configuration.

2. Description of the Related Art

A conventional trap for catching crabs, shrimps or the like is usually formed of a rigid cage and a net covering the cage. An accommodation in which baits can be provided is defined between the cage and the net for trapping crabs, shrimps or the like. Crabs, shrimps or the like crawl into the accommodation from doors provided at the net after the bait, are trapped. Since the cage of the aforesaid trap is an unfoldable rigid body, the conventional trap has disadvantages of occupying much stowage space and inconvenience in transportation.

### SUMMARY OF THE INVENTION

The present invention has been accomplished in view of the above-noted circumstances. It is an objective of the present invention to provide a catcher for catching crabs, shrimps or the like, which occupies less stowage space and is portable conveniently.

To achieve the objective of the present invention, a catcher for catching crabs, shrimps or the like comprises a flexible frame deformable between a retracted configuration and an extended configuration, and a net cover housing the flexible frame and having an inlet tunnel with a cross-section area inwardly and gradually decreased. When the flexible frame stays at the extended configuration, the net cover is supported by the flexible in such a manner that an accommodation in which baits can be provided is formed inside the net cover. Because the flexible frame provided by the catcher of the present invention is retractable, the catcher of the present invention can be set in the retracted configuration, such that it occupies less space when it needs to be stowed and/or transported.

Another aspect of the present invention is to provide a catcher for catching crabs, shrimps or the like that a user can easily remove the taking out from catcher. According to this aspect, the net cover is provided with a sealable and openable access for conveniently taking out the trapped crabs, shrimps or the like therefrom.

According to still another aspect of the present invention, the catcher of the present invention may further comprises a ring tab mounted to the flexible frame or the net cover, such that a number of catchers of the present invention can be simultaneously hung on a single rope by means of the ring tabs thereof for undergoing a mass catch.

Preferably, the catcher of the present invention may comprise a retainer for holding the catcher in the retracted configuration.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a perspective view of a catcher in accordance with a preferred embodiment of the present invention, showing that the catcher stays at the extended configuration, and

FIG. 2 is another perspective view of the catcher in accordance with the preferred embodiment of the present invention, showing that the catcher stays at the retracted configuration.

### DETAILED DESCRIPTION OF THE INVENTION

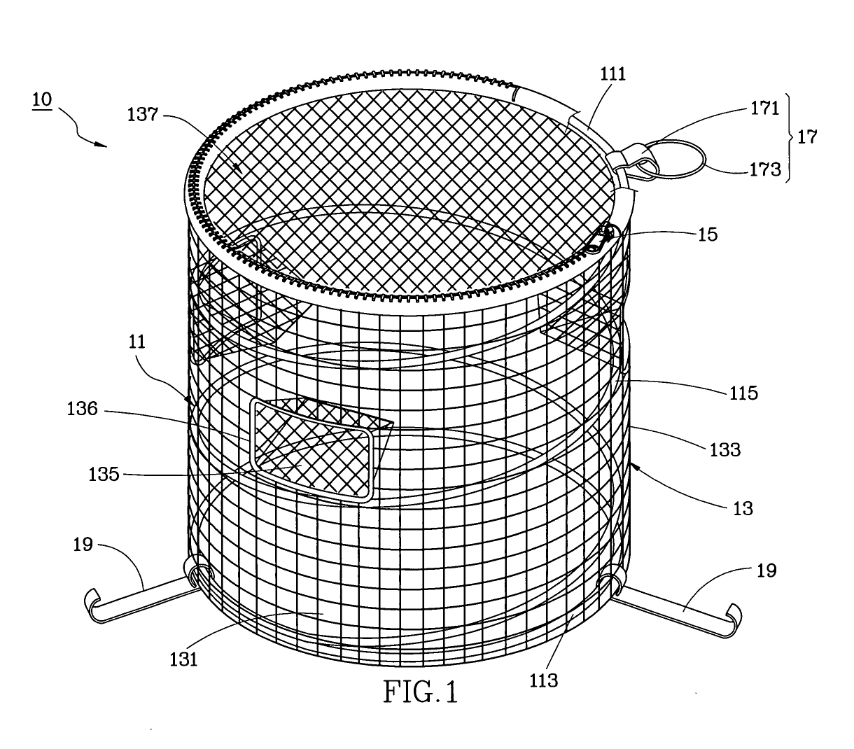

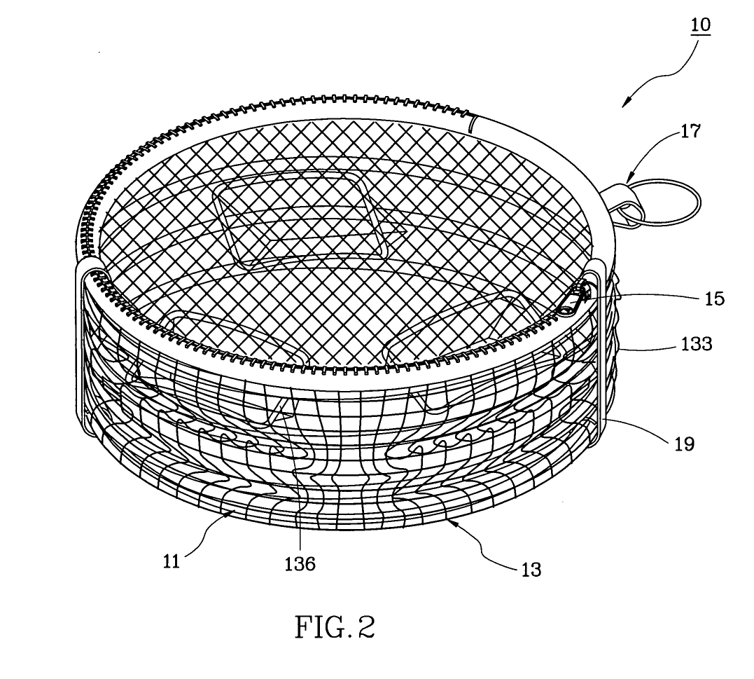

FIGS. 1-2 show a catcher for catching crabs, shrimps or the like, which is denoted with a reference numeral 10, in accordance with a preferred embodiment of the present invention. The catcher 10 comprises basically a flexible frame 11, a net cover 13, a zipper 15, a ring tab 17 and two retainers 19.

The flexible frame 11 is made of a metal wire and shaped like a spring coil, such that the flexible frame 11 is deformable between an extended configuration as shown in FIG. 1 and a retracted configuration as shown in FIG. 2. The flexible frame 11 includes a top end edge 111, a bottom end edge 113 and an elastic body section 115 between the top end edge 111 and the bottom end edge 113.

The net cover 13 houses the flexible frame 11 and is provided therein with an accommodation 131 in which baits can be provided when the net cover 13 is fully extended by the flexible frame 11 that stays at the extended configuration, as shown in FIG. 1. The net cover 13 has three inlet tunnels 135 equiangularly arranged at a lateral periphery wall 133 thereof. Each of the inlet tunnels 135 has a cross-section area inwardly and gradually decreased, that is, each inlet tunnel 135 has an entrance with a bigger cross-section and an exit with a smaller cross-section. A protective strip 136 is wrapped at the periphery of the entrance of each inlet tunnel 135 for maintaining the presetting shape of the entrance of the inlet tunnel 135 under a strong water or sea flow.

The zipper 15 is provided at the top periphery of the net cover 13, i.e. at the place where the net cover 13 contacts the top end edge of the flexible frame 11, such that a sealable and openable access 137 is formed at the top periphery of the net cover 13 for enabling the user to conveniently take out the crabs, shrimps or the like that crawl into the accommodation 131 of the net cover 13 from the inlet tunnels 135 and then are trapped inside the net cover 13.

FIG. 1 shows that the catcher 10 stays at the extended configuration. At this stage, the net cover 13 is fully supported and extended by the extended flexible frame 11 and the lateral periphery wall 133 of the net cover 13 corresponding to the elastic body section 115 of the flexible frame 11 is supported in a tension manner. On the other hand, FIG. 2 shows that the catcher 10 stays at the retracted configuration. At this stage, the lateral periphery wall 133 of the net cover 13 is in a loose and overlapped manner.

The ring tab 17 is metal made, having a mount 171 mounted to the top end edge 111 of the flexible frame 11, and a ring 173 connected with the mount 171 for insertion of a rope or the like for hanging the catcher 10.

The two retainer 19 each have an end pivotally connected with the bottom end edge 113 of the flexible frame 11 and a hook portion opposite to the pivotally-connected end and hookable on the top end edge 111 of the flexible frame 11 for holding the flexible frame 11 in the retracted configuration, as shown in FIG. 2.

It is to be noted that the retainer is embodied as, but not limited to, a hook as described above and shown in the drawings. For example, the retainer can be realized using a tying strip or the like. In addition, the number of the retainer is not limited too. One or more retainers can be used for holding the flexible frame in the retracted configuration.

As described above, because the flexible frame provided by the catcher of the present invention is retractable and extendable and can be held in the retracted configuration by the retainers, the catcher of the present invention has the advantages of occupying less stowage space and convenience in transportation, compared to the trap of prior art. In addition, the catcher is provided with a sealable and openable access for conveniently taking out the trapped crabs, shrimps or the like therefrom. Further, the ring tab enables the catcher to be hung on a rope, such that a number of catchers of the present invention can be simultaneously hung on a single rope for a mass catch.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A catcher for catching crabs, shrimps or the like, comprising:
a flexible frame deformable between a retracted configuration and an extended configuration, and
a net cover housing the flexible frame and having an inlet tunnel with a cross-section area inwardly and gradually decreased;
wherein when the flexible frame stays at the extended configuration, the net cover is supported by the flexible in such a manner that an accommodation is formed inside the net cover.

2. The catcher of claim 1, wherein the net cover comprises a sealable and openable access.

3. The catcher of claim 2, wherein the sealable and openable access is located at a place of the net cover where the net cover contacts an end edge of the flexible frame.

4. The catcher of claim 3, wherein the net cover is disposed with a zipper forming said sealable and openable access.

5. The catcher of claim 1, further comprising a ring tab mounted to one of said flexible frame and said net cover.

6. The cab catcher of claim 5, wherein the ring tab is mounted to an end edge of the flexible frame.

7. The cab catcher of claim 1, further comprising a retainer for holding the flexible frame in the retracted configuration.

8. The cab catcher of claim 7, wherein the retainer has an end pivotally connected with a bottom end edge of the flexible frame and a hook portion opposite to the end and hookable on a top end edge of the flexible frame.

9. The cab catcher of claim 7, wherein the retainer is a tying strip.
